(19) United States
(12) Patent Application Publication
(10) Pub. No.: US 2011/0317976 A1
(43) Pub. Date: Dec. 29, 2011

(54) SECURITY SYSTEM FOR OPTICAL PLUG-IN CONNECTOR

(75) Inventors: Oliver Eckstein, Wolfhausen (CH); Daniel Eigenmann, Wetzikon (CH)

(73) Assignee: REICHLE & DE-MASSARI AG, Wetzikon (CH)

(21) Appl. No.: 13/131,964

(22) PCT Filed: Nov. 27, 2009
(86) PCT No.: PCT/CH09/00379

§ 371 Date: Jun. 28, 2011

(30) Foreign Application Priority Data
Dec. 1, 2008 (CH) 1878/08

(51) Int. Cl. G02B 6/00

(52) U.S. Cl. 385/139

(57) ABSTRACT

A duplex adapter or duplex adapter part for a duplex plug of an optical plug-in connection includes two pairs of plug openings which are aligned to one another and into which in each case a duplex plug may be introduced from oppositely lying sides. It is formed from a housing and at least one frame which is fastened or fastenable on the housing and which projects proximally from the housing. The frame surrounds the two plug openings of an adapter side and comprises a middle portion which extends between the plug openings. A safety device for the plug side and which matches this, includes a duplex plug or a clip for creating a duplex plug from two simplex plugs, as well as an actuator for simultaneously activating unlocking pawls of both plugs.

### BACKGROUND OF THE INVENTION

1. Field of the Invention

The invention relates to the field of optical plug-in connectors and in particular to safety systems for optical plug-in connections.

2. Description of Related Art

Plug in connectors of the type “LC” are enjoying a growing popularity amongst the optical plug-in connectors, in particular due to the small shape factor. This small shape factor however has its price. The components of LC plug-in connectors are dimensioned in a very small manner with walls of minimum wall thicknesses. This on the one hands results in challenges with regard to manufacturing technology. Secondly, there is hardly any room for play for adding elements with further functionalities, for example safety elements. It is indeed such which are becoming more important, as the radiation powers which are transmitted via optical light waveguide connections in the meanwhile have become very large and render safety measures necessary, for reasons of personal safety and liability, as well as for reasons of operational reliability.

### BRIEF SUMMARY OF THE INVENTION

Accordingly, it is an object of the invention, to design an optical plug-in connection system in a manner such that, compared to the state of the art, additional safety features are present, without having to make compromises with regard to the demands of the shape factor. In particular, an LC duplex adapter or an LC duplex adapter part and an LC duplex plug are to be provided, which comprise additional safety features. It is further an object of the invention, to provide an LC duplex adapter which is more favourable with regard to manufacturing technology.

These objects are achieved by the invention as is defined in the patent claims.

According to a first aspect of the invention, it concerns a duplex adapter or a duplex adapter part (such a part may also serve for forming a receptacle) for a duplex plug, of the type “LC” or of a different, similar type with a small shape factor and preferably with a latch-in mechanism for the plug in the adapter/adapter part. A duplex adapter comprises two pairs of plug openings which are aligned to one another, into each of which a LC duplex plug introduced from opposite sides may be inserted in a manner such that light waveguides led in the plugs communicate with one another. A corresponding adapter part comprises two plug openings lying side by side and is intended, for example, to form an adapter together with a further identical adapter part, or where appropriate, to form with further components a receptacle for coupling onto a transmitter, receiver, transceiver or repeater. As is known per se, a separating wall is arranged between the adjacent plug openings. The adapter or the adapter part comprises an adapter housing and, at least on one side, a frame which is fastened on the outside of the adapter housing and surrounds both plug openings at the relevant side and comprises a portion extending between the plug openings. The frame serves the additional safety by way of it assuming one or more of the following functions:
Mechanical coding: the frame may have characteristic features (for example projections and/or recesses or the like, which project laterally into the plug opening or proximally away), and which, with corresponding features of the plug (in particular of a clip joining together the duplex plug) have the effect that a plug which matches with regard to the application may be introduced, but not a different one.
Color coding: the frame may have a color which is different to the housing and which is characteristic of the application.

Even if the principle of mechanical and/or color coding per se has been known for some time (for example from EP 0 616 236), aspects of the invention with the exchangeable, inexpensive coding frames provide a very good solution for the coding. In contrast to solutions, with which the coding is effected by the adapter or the adapter part or the plug as a whole, the solution suggested here is clearly to be preferred also with regard to storage stock and storage costs, since reserve supplies of adapters of different codes do not need to be present, but one adapter type is sufficient.
Protective flap: a particularly advantageous application of the frame is that it holds a radiation protection flap (“laser protection flap”). Due to lack of space, the fitting of a protective flap is practically impossible in an adapter part or adapter of the LC type, yet it is increasingly required for safety reasons. In a duplex adapter or duplex adapter part according to embodiments of the invention, the laser protection flap is designed as an elastic, metallic sheet-metal part, for example of spring steel, laid around a proximal end-edge of the separating wall and projecting into the plug openings in a manner covering the fibre-optic axes, and which is held by the frame. The sheet metal part may for example have the shape of a “V” in cross section, with arms bent outwards in a direction perpendicular to the separating wall, i.e. it may form two bent sheet-metal sections, whose convex sides project toward one another.

Important advantages result from the fact that, according to the idea suggested here, the protection flap is held by the frame:
Space availability: the protective flap may be fastened in a sturdy manner, which would take up additional (non-available) space. The protective flap merely needs to run between the separating wall and the middle portion (the intermediate web) of the frame, preferably with sections running on both sides along the separating wall from the separating wall end-edge inwards (i.e. in the distal direction).
Manufacture: the protective flap may be manufactured as a sheet metal part which is shaped in a suitable manner, wherein the manufacture may take place separately from the housing, i.e. for example no sections of the sheet metal part need to be bent around elements of the housing. The protective flap is inexpensive to manufacture and may even be retrofitted.
Safety: the protective flap—which is present on at least one side, preferably on both sides (the incoming side and the outgoing side)—provides reliable personal safety, even with faulty manipulation such as accidently pulling out a plug during running operation.

The frame and/or, where applicable, the laser protection flap, may be present on the adapter/the adapter part on one side only, or it or they may be attached on both sides (as a rule on the patch side).

The terms which are used in this text and which relate to the orientation such as “axial”/“axis”, “proximal”, “distal” are to be interpreted with respect to the plug-in connection. The axis corresponds to the optical axis, along which the light is led in the inserted condition and during operation. “Axial” means “parallel to the axis”. “Sideways” or “lateral” indicates non-axial directions. In a plug-in connection of this kind an optical plane is often also defined relating to the plane running perpendicularly to the axis, which, in a plug-plug connection, lies in the middle between the two ferrules of the plugs in the operating condition, thus quasi where the led light is transmitted from one plug to the other. “Distal” indicates the positions “at the front” of the plug, and “inside” the positions inside the plug opening, thus where appropriate, “towards the optical plane”. Where appropriate, “proximal” means “away from the optical plane”, thus “to the rear” of the plug and “outside” the plug opening. The terms “above” and below” are sometimes also used in this text. They relate to the orientation of an LC plug/adapter/receptacle, in which the actuation pawl lies at the top, and are of course not to be interpreted such that only systems with certain orientations in the construction are to be protected, but rather the invention does not depend on the orientation which is finally selected for the operation.

As is known per se, besides two unlocking pawls (one for each of the two plug portions of the duplex plug), a duplex plug, for example for an LC plug-in connection, for example for an adapter/a receptacle of the previously described kind, also comprises a common actuator. If the duplex plug is constructed of two, e.g. commercially available simplex plugs, which are connected to one another by a clip (duplex yoke), the clip comprises a corresponding actuator which is formed with the clip as one piece. This is designed as a flap which projects away from the plug axis in the distal direction and which projects beyond both unlocking pawls at the distal end, see for example also U.S. Pat. No. 7,413,351, EP 0 788 002 and U.S. Pat. No. 6,461,054.

According to a further aspect of the invention, a safety device is provided, which apart from the duplex plug as a whole or the clip, also comprises a removable actuation protection. This has a dimensionally rigid cover portion and covers the actuator to the proximal side. The actuation protection moreover comprises a guide portion, which for fastening, projects through an opening in the actuator to the distal side of the duplex plug. Due to the cover portion and/or the guide portion blocking a movement of the actuator, it may not be actuated without a tool. A direct, tool-free actuation of the locking pawls is likewise prevented. The guide portion is blocked by a locking mechanism, so that a removal of the actuation protection is prevented. In order to release the locking mechanism, an unlocking tool with a characteristic actuation portion must be inserted into the actuation protection. Preferably, the unlocking tool is formed in a characteristic manner and with regard to its dimensioning is matched to the opening in the actuation protection, and likewise belongs to the safety device. In principle, it would also be possible to alternatively design the actuation protection such that a commercially available tool may be used, for example a paper clip.

The locking mechanism may for example be a resilient locking tab of the clip or of the actuation projection, which locks in behind a locking projection of the actuation protection or of the clip. The unlocking tool, for example, moves the locking tab against its spring force in order to release the locking connection. An opening in the actuation protection for introducing the unlocking tool—with respect to the lateral position—may be in the inside of the opening in the actuator, so that an unlocking tool may be introduced such that it likewise projects through the actuator toward the distal side and actuates the locking projection located there.

The unlocking tool may moreover comprise retaining structures which cooperate with corresponding structures of the actuation projection, such that the actuation protection may be removed by way of pulling at the introduced unlocking tool in the opposite direction to the plug-in direction.

The safety functions of the frame (preferably with a laser protection flap) and of the actuation protection are preferably integrated as a whole concept, but may per se also be implemented independently of one another.

Besides the duplex adapter and the safety device, a safety set with the integrated safety functions of the frame and of the actuation protection preferably also comprises a plurality of further frames and clips (or possibly of whole duplex plugs), wherein the frame on the one hand and the clips on the other hand are preferably matched to one another with regard to their coding, i.e. there are certain types of frames which are only to be used and/or may only be used in conjunction with certain clips (and/or vice versa).

According to a further aspect of the invention, the LC adapter—simplex or duplex, with or without the previously discussed frame—comprises a single-piece plastic housing. Single piece plastic housings are already known per se in the field of the plug-in connections. Until now, however, they have hardly been considered for LC-adapters. The reason for this lies in particular in the manufacture of the receiver of the guide sleeve, or simply sleeve. The guide sleeve serves for guiding the ferrules of the two plugs to be connected. This receiver of the guide sleeve must of course be held or formed by the housing, and it must offer the guide sleeve a reliable seat, which in particular secures it also against axial forces caused by the friction of the ferrules on the sleeve during introduction into and withdrawal out of the adapter. The introduction of the guide sleeve according to the state of the art, for example described in EP 0 768 547, includes the introduction into a receiver half of the one connection half and the subsequent joining of the two connection halves forming the adapter. In that case, each receiver half could comprise a guide collar axially completely fixing the guide sleeve. With a manufacture as a single-piece housing however, the introduction of the guide sleeve would be made difficult, if not impossible by way of such guide collars.

Although U.S. Pat. No. 7,318,751 discloses an LC adapter with a single-piece metallic housing, a fastening cap to be specifically manufactured and fastened is required for the guide sleeve, which at least largely cancels out the advantages with regard to manufacturing technology of the single-piece design. EP 1 199 587 discloses a hybrid adapter with a single-piece housing, which however does not offer a practical solution to the problem of introducing the guide sleeve.

According to the aspect of the invention discussed here, the receiver for the guide sleeve is now formed on the single-piece plastic housing (i.e. it forms a constituent of the plastic housing and is thus of one piece with it), and for the locking fastening of the guide sleeve it is on at least one side designed with a snap mechanisms with a resilient element formed by the receiver itself. Thus, the guide sleeve may be held by the single-piece housing itself, without additional fastening elements.

For example, the receiver itself may be designed, as is known per se, in a sleeve-like manner with collars projecting inwards on both sides, wherein a plurality of axially running slots is present at least on the one side, by way of which the relevant side of the receiver is divided into segments, which on introduction of the guide sleeve may deflect outwards in a resilient manner.

### BRIEF DESCRIPTION OF THE DRAWINGS

Embodiments of the invention are described hereinafter in more detail by way of drawings. Reference numerals which are the same in the drawings indicate the same or analogous elements. There are shown in:

FIG. 1 a view of a duplex adapter;

FIG. 2 an exploded view of elements of the duplex adapter with a safety device according to FIG. 1;

FIG. 3 a duplex plug, as may cooperate with the duplex adapter;

FIG. 4 a clip for forming a duplex plug of the type represented in FIG. 3;

FIG. 5 a first coding frame for a duplex adapter of the type represented in FIG. 1;

FIG. 6 a mechanically coded clip as an alternative to that in FIG. 4;

FIG. 7 a coding frame as an alternative to that in FIG. 5, for cooperating with the clip according to FIG. 6;

FIG. 8 an exploded representation of a duplex plug with actuation protection and an unlocking tool;

FIG. 9 a view from below of the actuation protection;

FIG. 10 a view of the actuation protection which is sectioned along a plane through the axis of the plug connection;

FIG. 11 a view of the unlocking tool;

FIG. 12 a representation of the duplex plug according to FIG. 8 which is sectioned along a plane, with a partly introduced unlocking tool; and

FIG. 13 a detail of the single-part housing of the adapter with a receiver for the guide sleeve.

### DETAILED DESCRIPTION OF THE INVENTION

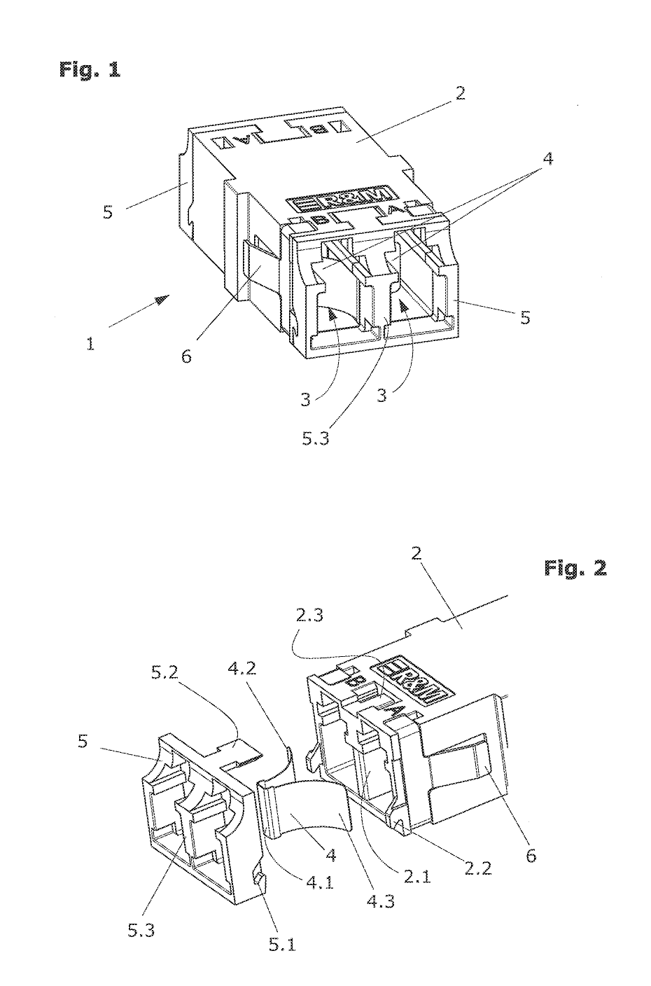

The duplex adapter 1 drawn in FIG. 1 for plug-in connections of the LC type comprises an injection-moulded plastic housing 2 which is of one piece in the represented embodiment. In the housing 2, plug openings 3 are formed and arranged side by side, which permit the receiving of standardised plugs or a standardised duplex plug of the type “LC”. A laser protection flap 4 is present inside the plug openings, which gives way against a spring force and releases the socket opening during introduction of the plug. During withdrawal, the laser protection flap moves back into the shown condition covering the axis of the light-guiding elements, due to the spring force, before the plug leaves the adapter. Moreover, a frame 5 clipped to the end-side is present and forms the proximal termination of the adapter 1. In the shown embodiment, the characteristic upper-side concave features of LC adapter sockets which are known per se are also formed on the frame. The frame surrounds both plug openings and comprises a middle portion (web) 5.3 extending between the plug openings.

As seen even more clearly in FIG. 2, the frame 5 has, amongst other things, the function of fixing the laser protection flap 4 by way of the bearing contact of the middle portion 5.3. The laser protection flap 4 is designed as a bent sheet-metal part, for example of spring steel, wherein the sheet-metal part forms a single laser protection flap for both plug openings 3. The sheet metal part forming the laser protection flap is laid around the separating wall 2.1 between the plug openings 3. For this purpose, the sheet-metal part comprises, apart from a web portion 41.1 bearing on the separating wall 2.1 at the end side, two wing portions 4.2, 4.3 which are bent away therefrom at angles and each of which forms the laser protection flap portion for one of the two plug openings. From the web portion, the wing portions first run projecting away from it in the distal direction essentially parallel to the separating wall and then, as a function of the distance to the web portion, run in a continuous manner bent towards the perpendicular to the separating wall, so that as a whole, in a horizontal cross section, they comprise the shape of a V with continuously outwardly curved arms. (One might also speak of arms in the form of sections of a cycloid). This shape is particularly advantageous, since it ensures that a certain stress level is not exceeded at any point during the introduction of the plug and the deformation of the sheet-metal part which this entails, so that an essentially elastic deformation takes place across the whole region. If, in contrast, the sheet-metal part, for example connecting to the web portion, were to project perpendicularly or at a large angle away from the separating wall, then with a deformation, very large stresses would result in the region of the transition to the web portion, so that a purely elastic deformation would no longer be given with a frequent plugging in and out. A further advantage of this shape is that the exiting laser beams are not coupled back into the fibres/the plug by way of reflection.

The described shape of the laser protection flap 4 moreover, due to the sections connecting to the web portion in a manner running parallel to the separating wall 2.1, have the further advantage that the orientation of the laser protection flap is also defined when the frame 5, as in the embodiment example shown here, is flat towards the distal side in the region of the middle portion 5.3, thus only bears on the web portion 4.1 of the laser protection flap.

Locking means are present for fixing the frame 5 on the housing 2 and these locking means are designed as suitable formations 2.2, 2.3; 5.1, 5.2 on the housing and on the frame, and whose exact shape is not essential to the invention and is therefore not described in more detail here.

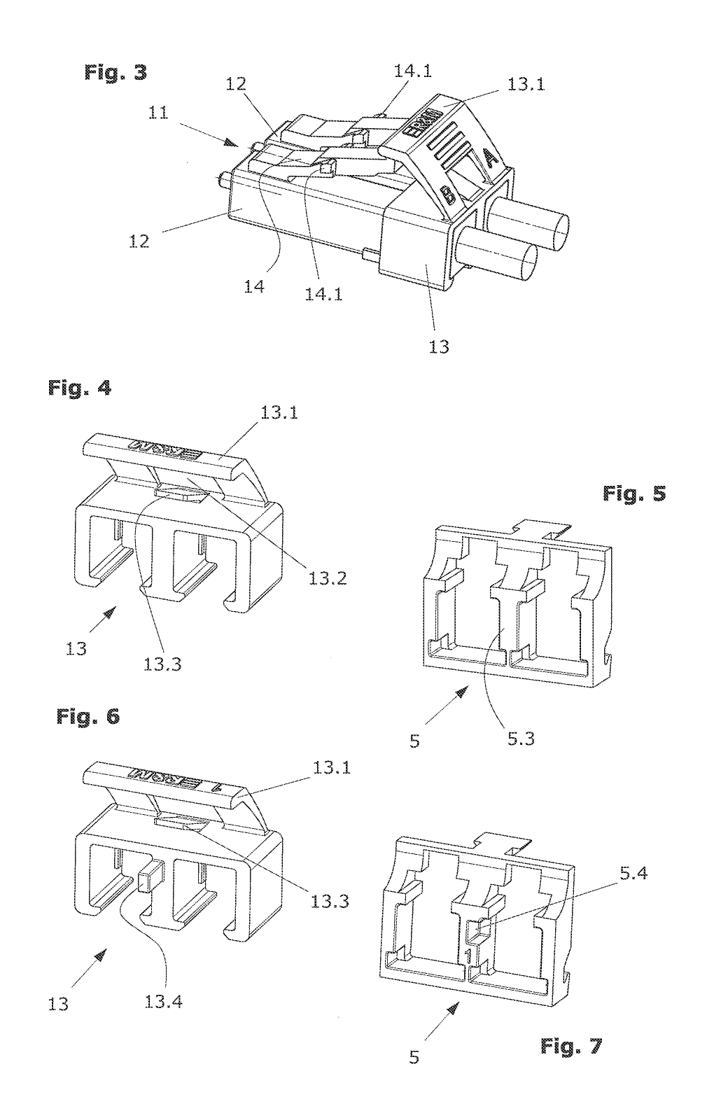

FIG. 3 shows a duplex plug 11, as may be used with the adapter according to FIGS. 1 and 2. The duplex plug 11, as is known per se, is composed of two commercially available simplex plugs 12 which are connected by a clip 13. The simplex plugs 12 comprise unlocking pawls 14, which effect a locking upon insertion into the adapter, and by way of whose actuation the adapter-plug connection may be unlocked again. The structures of the unlocking pawls 14, which with the locking, lock in behind corresponding structures of the adapter, are indicated in the figure at 14.1. The clip comprises an actuator 13.1 which is formed out as one part with the clip. This is designed as a flap which projects beyond both unlocking pawls and which is formed as one piece with the rest of the clip. Both unlocking pawls 14 are simultaneously actuated by way of an actuation of the actuator.

FIG. 4 shows the clip 13 in a different representation. An opening 13.2 is formed in the actuator 13.1, and moreover a resilient locking tab 13.3 joins in the region of the opening. The functions of the opening and of the locking tab are described in detail hereinafter.

The frame 5, apart from the already mentioned functions, also acts as a coding frame. This means that the frame on the one hand by way of the color selection may signalise a suitability of the plug-in connection for certain applications, and for example indicates that only plugs with a clip which is matching in color may be stuck on. Additionally, or as an alternative, the frame may also comprise mechanical features which cooperate with corresponding mechanical features of the duplex plug, in particular of the clip, so that only matching plugs may be inserted—and/or plugs may only be inserted into matching adapters. FIG. 5 shows a frame 5 of the code “neutral” which fits with a clip 13 of the type drawn in FIG. 4. FIGS. 6 and 7 show a clip 13 or a frame 5 with a code which is different therefrom and which is effected by way of a projection 13.4 on the clip and a corresponding recess 5.4 on the frame 5. A duplex plug with the clip 13 according to FIG. 6 may not be inserted into an adapter with the frame according to FIG. 5. Many further codes are possible. The design of the mechanical code between the frame 5 and the clip 13 may also be designed inversely to the previously described type, i.e. with a coding projection on the frame and a corresponding recess in the clip.

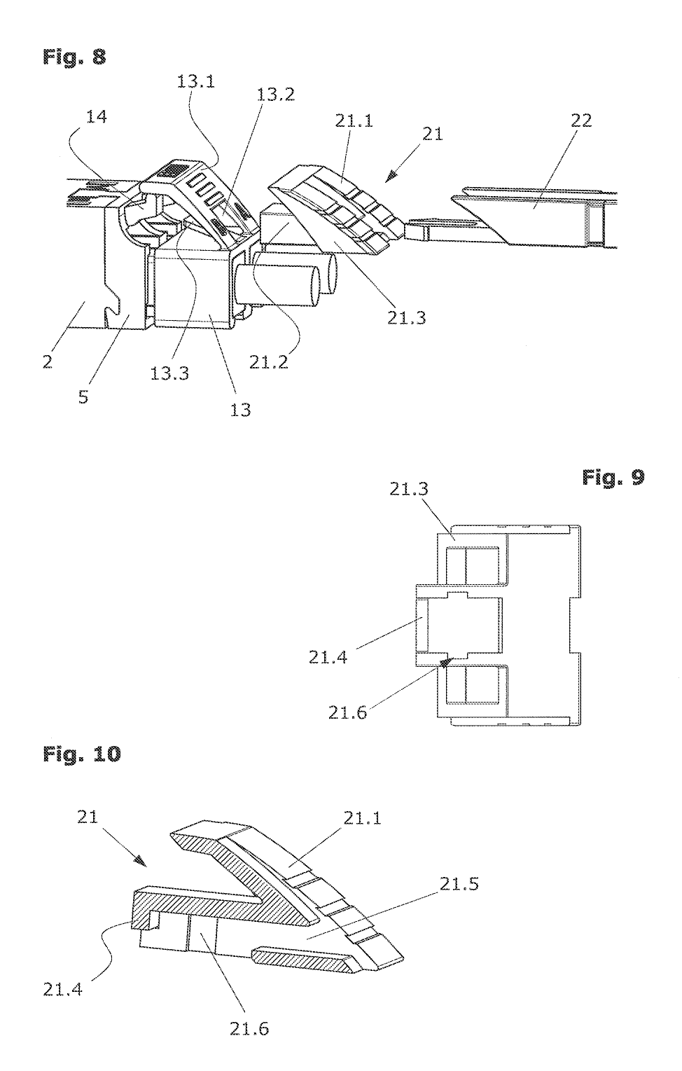

FIG. 8 represents an arrangement with an actuation protection. FIG. 8 shows the duplex plug 11 of FIG. 3 inserted into the adapter 2. An actuation protection 21 is additionally visible, which is also represented in FIGS. 9—in a different view—and FIG. 10 (partly sectioned).

The actuation protection comprises a dimensionally rigid cover portion 21.1 and a guide portion 21.1. In the shown embodiment example, the stiffness of the cover portion is supported by lateral reinforcements 21.3. The guide portion may be inserted into the opening 13.2 until the actuation protection encounters an abutment. In this case, the cover portion 21.1 covers the actuator 13.1 to the proximal side—the actuator is no longer accessible and may not be actuated without a tool, i.e. by hand and without intending to manipulate. Moreover, the locking tab 13.3 which is pressed downwards upon introduction of the cover protection, locks behind the transverse wall 21.4 and secures the actuation protection from withdrawal. The actuation protection may also not be removed without a tool.

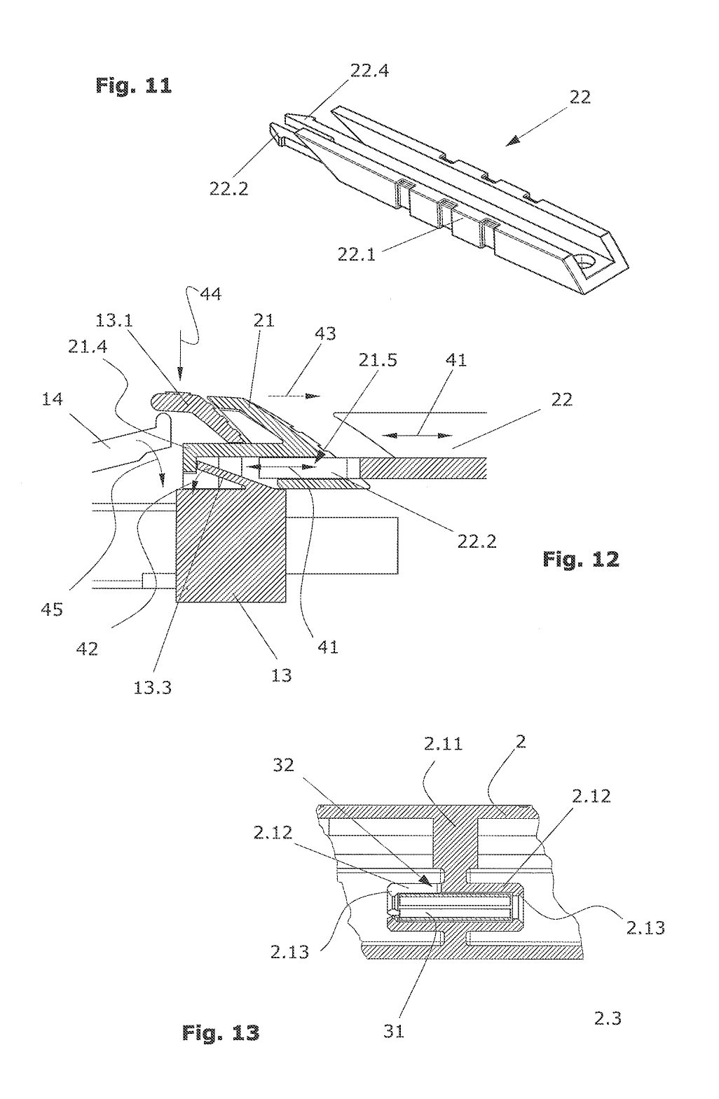

An unlocking tool 22 is required for releasing the locking connection, as is represented in FIG. 8 and FIG. 11. The locking tool, apart from a handgrip portion 22.1, also comprises an actuation portion 22.2 which is led through the opening 21.5 (see FIG. 10) in the actuator into the cavity which exists behind the transverse wall 21.4 between the actuation protection 21 and the clip 13 and in which the locking tab 13.3 is located. By way of the insertion, the locking tab is deflected downwards and releases the actuation protection for the removal by way of pulling in the proximal direction. The actuation portion 22.2 of the unlocking tool moreover comprises retaining structures 22.4 which effect a locking of the unlocking tool with the actuation protection, so that this may be removed by way of pulling on the unlocking tool. The retaining structures 22.4 in the represented embodiment example are designed as retaining lugs which at the front side are attached on resilient limbs forming the actuation portion and lock in a widening 21.6 in the actuation protection.

FIG. 12 shows the above described deflection of the locking tab 13.3 by the unlocking tool 22. The unlocking procedure firstly envisages the insertion of the unlocking tool 22 into the opening 21.5 up to an abutment (arrow 41). By way of this, the locking tab 13.3 is pressed downwards (arrow 42) and releases the actuation protection 21 for removal (arrow 43), for example by way of pulling on the unlocking tool 22 which is engaged in the actuation protection. Subsequent to this, the actuator 13.1 may be actuated (arrow 44), which effects a release of the locking pawl (arrow 45).

As one likewise sees in FIG. 12, here the blocking of the actuator 13.1 is either effected by the covering and its rendering inaccessible by the actuation protection 21, or by way of a guide portion bearing on the delimitation of the opening 13.2 resulting in a pivot movement being blocked or by way of both these means, as is shown in the figure.

The previously discussed aspect of the invention was described by way of a duplex plug formed by two initially separate simplex plugs 12 which are held together by a clip 13. The invention may just as well be implemented with duplex plugs whose two plug housings are as one piece together or which are fastened together in any other manner, wherein then the actuator may be formed by the common housing.

The above figures describe the invention by way of a single-piece adapter. A corresponding adapter part (not drawn) for example corresponds essentially to one half of the adapter drawn in FIG. 1, with the features drawn in the subsequent figures. It may also be designed as a so-called receptacle and thus, for example, serve for coupling to a transmitter, receiver, transceiver or repeater.

FIG. 13 shows a detail of the receiver of the guide sleeve 31, which is formed by the preferably single-piece plastic housing 2. The receiver penetrates the base wall 2.11 which is arranged roughly in the middle with respect to the axial direction. The base wall lies, for example, roughly on the optical plane. The receiver 2.12 is itself designed in a sleeve-like manner with an inner diameter which is adapted to the outer diameter of the guide sleeve 31. It comprises, in each case, a collar 2.13 on both sides, which secures the guide sleeve against axial displacements. The receiver is slotted several times (represented as a slot 32) on one side at least, so that it is divided into a plurality of axially running segments which may deflect resiliently outwards upon introducing the guide sleeve from the slotted side.

The concept of the single-piece design which is described here may be also applied without further ado to simplex adapters and to plugs of different types than of the type LC.

1. A safety device for an optical plug connection, comprising:
a duplex plug with two part plugs, or a clip for creating a duplex plug from two simplex plugs,
as well as an actuator for the simultaneous actuation of unlocking pawls of both part plugs or simplex plugs;
an actuation protection with a dimensionally rigid cover portion for covering the actuator towards a proximal side, and with a guide portion cooperating with the duplex plug or clip;
which wherein the guide portion may be locked with the duplex plug or clip in such a manner that it can not be released from this the duplex plug or clip without a tool.

2. A The safety device according to claim 21, the duplex plug or clip defining a plug axis, wherein the actuator is designed as a flap projecting away from the plug axis in the distal direction and comprises an actuator opening through which the guide portion projects in the locked condition.

3. The safety device according to claim 1, wherein the actuation protection comprises an opening, wherein the safety device further comprises an unlocking tool, on which an actuation portion is formed, of which a cross section is matched to a cross section of the opening, and wherein the unlocking tool, by way of introducing the actuation portion into the opening, releases a lock between the actuation protection and the duplex plug or clip.

4. The safety device according to claim 3, wherein the unlocking tool comprises retaining structures which effect an engaging of the unlocking tool in the actuation protection, so that the actuation protection is removable from the duplex plug or clip by way of pulling at the unlocking tool.

5. The safety device according to claim 3, wherein the opening of the actuation protection extends through the actuator opening.

6. The safety device according to claim 3, wherein a locking mechanism effecting the locking of the guide portion with the duplex plug or the clip is formed by a resilient tab of the duplex plug or of the clip, which locks in behind a locking projection of the actuation protection or of the clip.

7. A duplex adapter or duplex adapter part for a duplex plug of an optical plug-in connection, comprising,
a housing and
two plug openings which lie side by side and into which a duplex plug may is introduceable,
wherein a separating wall is arranged between the plug openings lying side by side, the duplex adapter further comprising a frame which is fastened or fastenable to the housing, the frame projects proximally from the housing, surrounding the two plug openings of an adapter side, and comprising a middle portion extending between the plug openings.

8. The duplex adapter or duplex adapter part according to claim 7, wherein the frame is coded by at least one of colour and of a mechanical coding.

9. The duplex adapter or duplex adapter part according to claim 7, further comprising a radiation protection flap, which projects into the inside of the plug openings, in the absence of an inserted plug, in a first position, covers an optical axis of the plug openings concerned, and may be deflected against a spring force out of the first position by way of introducing a plug, wherein the radiation protection flap is fixed on the housing by the frame.

10. The duplex adapter or duplex adapter part according to claim 9, wherein the radiation protection flap is manufactured as one piece from an elastically deformable sheet-metal part comprising two wings which cover the optical axis of the first and of the second adjacent plug openings respectively.

11. The duplex adapter or duplex adapter part according to claim 10, wherein the radiation protection flap comprises a web portion which runs between the separating wall and the middle portion of the frame and from which the two wings project one on each side into the first and into the second plug opening, wherein each of the wings, from connecting to the web portion, firstly runs in the distal direction and subsequently is bent in a continuous manner towards the perpendicular to the separating wall.

12. The duplex adapter according to claim 7, comprising two pairs of plug openings which are aligned to one another and into each of which a duplex plug may be introduced from the opposite side, wherein the housing is of one piece and forms the total of four plug openings aligned in pairs, wherein the duplex adapter moreover comprises two guide sleeves for guiding aligning plug ferrules, wherein the housing, per pair of plug openings aligned to one another, forms a receiver for one of the guide sleeves, wherein the receiver is designed in a sleeve-like manner with a radial inwardly projecting collar on either side at the end-side, and wherein the receiver comprises on at least one side a plurality of axially running slots.

13. A safety set for a system of optical plug connections, comprising a duplex adapter or a duplex adapter part for a duplex plug of an optical plug-in connection, with a housing and two plug openings which lie side by side and into which a duplex plug may be introduced, wherein a separating wall is arranged between the plug openings lying side by side, with a frame which is fastened or fastenable to the housing, projects proximally from the housing, surrounds the two plug openings of an adapter side, and comprises a middle portion extending between the plug openings, the set further comprising at least one safety device interacting with the duplex adapter or duplex adapter part, the safety device comprising:
a duplex plug with two part plugs , or a clip for creating a duplex plug from two simplex plugs ;
an actuator for the simultaneous actuation of unlocking pawls of both part plugs or simplex plugs ;
an actuation protection with a dimensionally rigid cover portion for covering the actuator towards a proximal side, and with a guide portion cooperating with the duplex plug or clip;
wherein the guide portion may be locked with the duplex plug or clip in such a manner that it can not be released from the duplex plug or clip without a tool.

14. The safety set according to claim 13, further comprising at least one further frame, whose colour and/or shape is different from the colour and/or shape of a first frame, and at least one further duplex plug or clip, whose colour and/or shape is different from the colour and/or shape of a first duplex plug or clip, resulting in a system of matching colour codes and/or mechanical codes of the frame and of the duplex plug or clip.
